(19) United States
(12) Patent Application Publication
(10) Pub. No.: US 2026/0147903 A1
(43) Pub. Date: May 28, 2026

(54) MEMORY SYSTEM, MEMORY DEVICE, AND OPERATING METHOD THEREOF

(71) Applicant: Samsung Electronics Co., Ltd., Suwon-si (KR)

(72) Inventors: Sewon Kim, Suwon-si (KR); Mingon Shin, Suwon-si (KR); Younsung Chu, Suwon-si (KR); Byungchan Choi, Suwon-si (KR)

(21) Appl. No.: 19/260,090

(22) Filed: Jul. 3, 2025

(30) Foreign Application Priority Data
Nov. 25, 2024 (KR) 10-2024-0170060

(51) Int. Cl. G06F 21/60; G06F 11/10; G06F 21/79

(52) U.S. Cl. CPC G06F 21/602; G06F 11/1004; G06F 21/79

(57) ABSTRACT

A memory system includes a host and a memory device. The memory device is configured to: receive, from the host, user data, user data encryption key, and metadata for the user data encryption key; generate a combined key based on the user data encryption key and the metadata; in a write operation, (i) generate encrypted user data by encrypting the user data based on the combined key, (ii) generate a first cyclic redundancy check (CRC), and (iii) store the encrypted user data and the first CRC; and in a read operation, (i) generate decrypted user data by decrypting the encrypted user data based on the combined key, (ii) generate a first comparison CRC, and (iii) detect a change in the combined key based on comparing the first CRC with the first comparison CRC.

### CROSS-REFERENCE TO RELATED APPLICATION

This application claims priority to Korean Patent Application No. 10-2024-0170060, filed on November 25, 2024, the disclosure of which is incorporated herein by reference in its entirety.

### BACKGROUND

As the importance of data security has increased, attention has been given to various techniques for encrypting user data within memory systems. In this context, maintaining both the security and operational efficiency of memory systems has become an important consideration.

### SUMMARY

In some examples, to maintain the security of user data in a memory system, a method of injecting a user data encryption key into a memory device can be used. In other words, when a user data encryption key is injected into a memory device and the user data is encrypted, the memory system can perform various operations of the memory device. Therefore, when the user data is not encrypted due to an error in the user data encryption key, the memory device may not operate normally.

Metadata for the user data encryption key can be used to detect errors in the user data encryption key. It is desired to allocate a storage space to store the metadata, which can lead to inefficient use of the storage space.

Implementations according to this disclosure address the issues such as those described above. In an example, implementations according to present disclosure provides a memory system, a memory device, and an operating method that are capable of generating a combined key based on a user data encryption key and metadata for the user data encryption key, and performing encryption and decryption operations using the generated combined key to maintain security for the user data without allocating a storage space for storing metadata.

An aspect of the present disclosure provides a memory system including a host and a memory device. The host can be configured to receive a user data encryption key from a server. The memory device can be configured to: receive, from the host, user data, the user data encryption key, and metadata for the user data encryption key; generate a combined key based on the user data encryption key and the metadata; in a write operation, (i) generate encrypted user data by encrypting the user data based on the combined key, (ii) generate a first cyclic redundancy check (CRC) based on the user data, and (iii) store the encrypted user data and the first CRC; and in a read operation, (i) generate decrypted user data by decrypting the encrypted user data based on the combined key, (ii) generate a first comparison CRC based on the decrypted user data, and (iii) detect a change in the combined key based on comparing the first CRC with the first comparison CRC.

Another aspect of the present disclosure provides a memory device including at least one core, a security circuit, a cyclic redundancy check (CRC) generation circuit, a non-volatile memory, and a CRC comparison circuit. The at least one core can be configured to generate a combined key based on a user data encryption key and metadata for the user data encryption key. The security circuit can be configured to (i) generate encrypted user data by encrypting user data based on the combined key while a write operation is being performed by the memory device, and (ii) generate decrypted user data by decrypting the encrypted user data based on the combined key while a read operation is being performed by the memory device. The CRC generation circuit can be configured to (i) generate a first CRC based on the user data and (ii) generate a first comparison CRC based on the decrypted user data. The non-volatile memory can be configured to store the encrypted user data and the first CRC. The CRC comparison circuit can be configured to detect a change in the combined key based on comparing the first CRC with the first comparison CRC.

Another aspect of the present disclosure provides an operating method of a memory device. The operating method can include: receiving, from a host, at least one key tag, a user data encryption key, and metadata; generating a combined key based on the user data encryption key and the metadata; mapping the at least one key tag and the combined key on a one-to-one basis; receiving, from the host, user data and a first key tag among the at least one key tag; generating a first cyclic redundancy check (CRC) based on the user data; generating encrypted user data by encrypting the user data based on the combined key mapped to the first key tag; generating decrypted user data by decrypting the encrypted user data based on the combined key mapped to the first key tag; generating a first comparison CRC based on the decrypted user data; and detecting a change in the combined key based on comparing the first comparison CRC with the first CRC.

### BRIEF DESCRIPTION OF THE DRAWINGS

FIG. 1 is a block diagram illustrating an example of a memory system.

FIG. 2 is a flowchart illustrating an example of an operating method of a memory device.

FIG. 3 is a flowchart illustrating an example of an operating method of a memory device.

FIG. 4 shows a diagram illustrating an example of aa storage space of a memory device and a diagram illustrating a comparative example of a storage space of a memory device.

FIG. 5 is a flowchart illustrating an example of an operating method of a memory device.

FIG. 6 is a flowchart illustrating an example of an operating method of a memory device.

FIGS. 7 to 9 are block diagrams illustrating examples of operations of a memory device.

FIG. 10 is a flowchart illustrating an example of an operating method of a memory system.

FIG. 11 is a flowchart illustrating an example of an operating method of a memory system.

FIG. 12 is a block diagram illustrating an example of a host-storage system.

### DETAILED DESCRIPTION

Hereinafter, implementations of present disclosure will be described in detail with reference to the accompanying drawings.

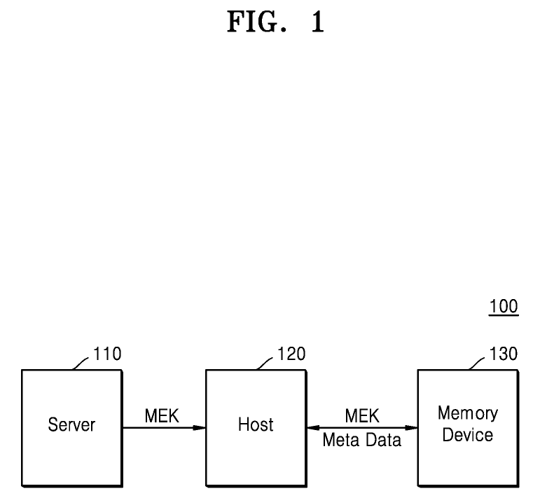

FIG. 1 is a block diagram illustrating a memory system 100.

Referring to FIG. 1, the memory system 100 can include a server 110, a host 120, and a memory device 130. The server 110 can manage a user data (or media) encryption key (MEK). In some implementations, the server 110 can be a MEK management server, and can allow the host 120 to use a MEK by generating the MEK in advance and transmitting the generated MEK to the host 120, or transmitting data including information of the MEK to the host 120.

In some implementations, the MEK can enable user data of the memory device 130 to be encrypted so that the memory device 130 may not know the user data. For example, when the user is a customer, the memory system 100 can prevent the manufacturer of the memory device 130 from knowing the customer's data by utilizing the MEK.

The host 120 can receive a MEK from the server 110. In some implementations, the host 120 can receive a MEK managed by the server 110 or can receive data including information of the MEK, and use the MEK.

The host 120 can perform an injection operation of injecting the MEK and the metadata into the memory device 130. In some implementations, the host 120 can generate metadata for the MEK, and can inject the MEK and the metadata into the memory device 130. The metadata can be data on the MEK. For example, metadata can include a key unique-identifier (KeyUID), which means an identifier of a key. For example, metadata can include data related to a unique identifier, a name space, a key tag, etc.

The memory device 130 can receive a MEK and metadata from the host 120 and perform input/output processing operations on the user data, which is media data. The input/output processing operation can mean an operation of encrypting user data and inputting the encrypted user data to the memory device 130, decrypting the encrypted user data and outputting the decrypted user data from the memory device 130. The input/output processing operation can include a write operation for inputting user data to the memory device 130 and a read operation for outputting user data from the memory device 130.

In some implementations, the memory device 130 can generate a combined key based on the MEK and the metadata of the MEK. The combined key can mean a key generated to include both information on the MEK and the metadata.

For example, the combined key can be a key generated by performing an exclusive OR (XOR) operation. The XOR operation can mean a logical operation for determining a case in which only one of the two propositions is true. For example, metadata can include a KeyUID, which is a unique identifier of the MEK, and the memory device 130 can generate a combined key by performing an XOR operation on the KeyUID and the MEK. For example, the MEK can include an encryption key (eKey) used for actual data encryption and a tweak key (tKey) used for generating a tweak value, and the memory device 130 can generate a combined key by performing an XOR operation on at least one of eKey, tKey, and an initialization vector (IV) that plays a random number role in the encryption process, and metadata.

For example, the combined key can include a first key corresponding to a MEK and a second key corresponding to metadata.

In some implementations, the memory device 130 can encrypt user data using the generated combined key. For example, in a write operation, the memory device 130 can generate encrypted user data by encrypting user data based on the generated combined key, and can generate cyclic redundancy check (CRC) by performing a CRC generation operation to check whether there is an error in the transmitted data based on the user data.

In some implementations, the memory device 130 can include a non-volatile memory and can store encrypted user data and generated CRC in the non-volatile memory. For example, the memory device 130 can be a solid-state drive (SSD), but is not limited thereto and can include a volatile memory or another type of non-volatile memory. For example, non-volatile memory can include a plurality of data blocks, and the memory device 130 can store encrypted user data and generated CRC in each of the plurality of data blocks of the non-volatile memory.

In some implementations, the memory device 130 can use the generated combined key to detect whether the combined key has been changed. For example, in a read operation, the memory device 130 can generate decrypted user data by decrypting stored encrypted user data based on the generated combined key, and can generate comparative CRC by performing a CRC generation operation based on decrypted user data. The memory device 130 can compare the comparison CRC with the stored CRC. When the comparison CRC and the CRC do not match each other, the memory device 130 can generate a first error code. The first error code can be an error code indicating that the combined key has been changed, and can be referred to as an incorrect key error. When the comparison CRC and CRC match each other, the memory device 130 can determine that the combined key has not been changed and can output decrypted user data to the host 120.

Since the memory system 100 can perform input/output processing operations using the combined key, it can be determined whether the key has been changed without having to separately store metadata in the non-volatile memory. Accordingly, security of user data can be maintained without allocating a storage space for storing metadata.

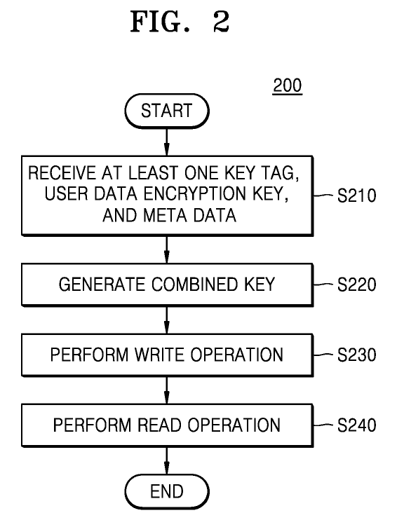

FIG. 2 is a flowchart illustrating an operating method 200 of an example of a memory device. Referring to FIG. 2, the operating method 200 of a memory device can include a plurality of operations S210 to S240, and the memory device can be the same as the memory device 130 of FIG. 1.

Referring further to FIG. 1, in operation S210, the memory device 130 can receive at least one key tag, a MEK, and metadata. The key tag can mean data that provides identification information for a specific encryption key, and can be used to identify and manage a key. In some implementations, the host 120 can perform an injection operation of injecting at least one key tag, a MEK, and metadata into the memory device 130.

In operation S220, the memory device 130 can generate a combined key. In some implementations, the memory device 130 can generate a combined key based on the MEK and metadata, and can map the generated combined key and at least one key tag on a one-to-one basis. For example, the memory device 130 can include a plurality of key indices, and the at least one key tag and the generated combined key can be mapped to each of the plurality of key indices one by one. In other words, one mapped key tag and one combined key can be connected by the same key index. When a first key tag (KeyTag 0) and a first combined key (Combined Key 0) are connected to a first key index (Key Index 0), the KeyTag 0 and the Combined key 0 can be expressed as being mapped on a one-to-one basis.

In operation S230, the memory device 130 can perform a write operation. In some implementations, when performing a write operation, the memory device 130 can receive a KeyTag 0 among at least one key tag and user data from the host 120. The memory device 130 can generate a CRC based on the received user data, and can generate encrypted user data by encrypting the received user data based on a combined key (e.g., a Combined Key 0) mapped to the KeyTag 0. The memory device 130 can store CRC and encrypted user data in a non-volatile memory.

In operation S240, the memory device 130 can perform a read operation. In some implementations, when performing a read operation, the memory device 130 can receive a first key tag (KeyTag 0) among at least one key tag from the host 120. The memory device 130 can generate decrypted user data by decrypting encrypted user data based on a combined key (e.g., a first combined key (Combined Key 0)) mapped to the KeyTag 0, and can generate a comparison CRC based on the decrypted user data. The memory device 130 can compare the comparison CRC with the stored CRC to detect whether the combined key has been changed. For example, when the comparison CRC and the stored CRC match each other, the memory device 130 can detect that the combined key has not been changed, and when the comparison CRC and the stored CRC do not match each other, the memory device 130 can detect that the combined key has been changed.

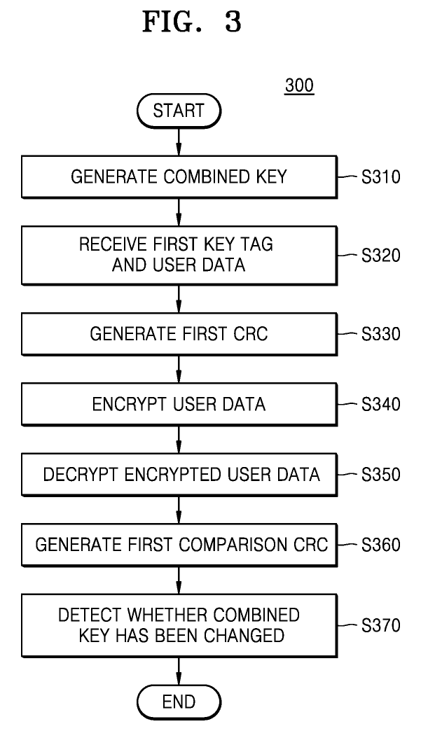

FIG. 3 is a flowchart illustrating an example of an operating method 300 of a memory device. Referring to FIG. 3, the operating method 300 of a memory device can include a plurality of operations S310 to S370, and the memory device can be the same as the memory device 130 of FIG. 1.

Referring further to FIGS. 1 and 2, operation S310 can be an operation performed after operation S210 and can be an example of operation S220. In operation S310, the memory device 130 can generate a combined key. In some implementations, the memory device 130 can generate a combined key by performing an XOR operation based on the MEK and metadata, and can map the generated combined key and at least one key tag on a one-to-one basis.

For example, the metadata can include a KeyUID that is a unique identifier of a media encryption key (MEK). The memory device 130 can generate a plurality of combined keys by performing an XOR operation on the KeyUID and the MEK, and can map at least one key tag and the plurality of combined keys to each of the plurality of key indices on a one-to-one basis.

For example, the MEK can include an encryption key (eKey) used for actual data encryption and a tweak key (tKey) used for generating a tweak value. The memory device 130 can generate a plurality of combined keys by performing an XOR operation on at least one of eKey, tKey, and an initialization vector (IV) that plays a random number role in an encryption process and metadata, and can map at least one key tag and the plurality of combined keys to each of the plurality of key indices on a one-to-one basis.

In operation S320, the memory device 130 can receive a first key tag and user data. In some implementations, the memory device 130 can receive a KeyTag 0 among at least one key tag and user data from the host 120.

In operation S330, the memory device 130 can generate a first CRC. In some implementations, the memory device 130 can generate the first CRC based on the received user data.

In operation S340, the memory device 130 can encrypt user data. In some implementations, the memory device 130 can generate encrypted user data by encrypting received user data based on a combined key (e.g., a first combined key (Combined Key 0)) mapped to the KeyTag 0. The memory device 130 can store first CRC and encrypted user data in a non-volatile memory.

In operation S350, the memory device 130 can decrypt the encrypted user data. In some implementations, the memory device 130 can receive a KeyTag 0 among at least one key tag from the host 120. The memory device 130 can generate decrypted user data by decrypting the encrypted user data based on the combined key (e.g., the Combined Key 0) mapped to the KeyTag 0.

In operation S360, the memory device 130 can generate a first comparison CRC. In some implementations, the memory device 130 can generate a first comparison CRC based on the decrypted user data.

In operation S370, the memory device 130 can detect whether the combined key has been changed. In some implementations, the memory device 130 can compare the first comparison CRC with the first CRC to detect whether the combined key has been changed. For example, when the first comparison CRC and the first CRC match each other, the memory device 130 can detect that the combined key has not been changed, and when the first comparison CRC and the first CRC do not match each other, the memory device 130 can detect that the combined key has been changed.

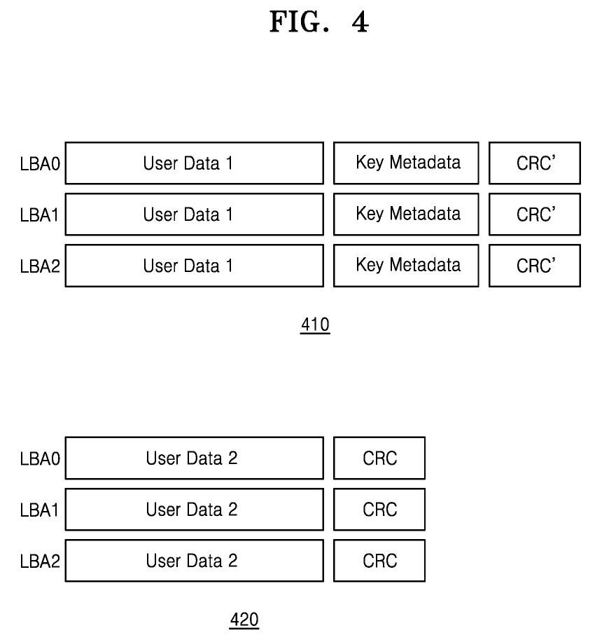

FIG. 4 shows a diagram illustrating an example of a storage space of a memory device and a diagram illustrating a comparative example of a storage space of a memory device.

Referring to FIGS. 1 and 4, the storage space 410 of the memory device 130 of FIG. 1 according to the comparative implementation represents a part of the storage space of the non-volatile memory included in the memory device 130 of the comparative example, and the storage space 420 of the memory device 130 of FIG. 1 represents a part of the storage space of the non-volatile memory included in the memory device 130. The non-volatile memory can include a plurality of data blocks corresponding to a plurality of logical block addresses (LBA) indicating addresses of the data blocks. For example, each of the storage spaces 410 and 420 can include three data blocks, and each data block can correspond to one LBA. The first data block of the three data blocks can correspond to LBA0, the second data block of the three data blocks can correspond to LBA1, and the third data block of the three data blocks can correspond to LBA2.

When performing a write operation, the memory device of the comparative implementation can generate encrypted user data (User Data 1) by encrypting user data based on the MEK, and can generate CRC' by performing a CRC generation operation to check whether there is an error in the transmitted data based on the User Data 1. The memory device of the comparative implementation can store, in the non-volatile memory, metadata (Key Metadata) for detecting whether the MEK has been changed, together with the User Data 1 and the CRC'. For example, the Key Metadata can correspond to the MEK, and the memory device of the comparative implementation can store, in each of the plurality of data blocks, the User Data 1, the CRC', and the Key Metadata corresponding to the MEK used for encryption. Accordingly, each of the plurality of data blocks can require a storage space for storing the Key Metadata.

Since the memory device 130 according to an implementation of the present disclosure detects encryption, decryption, and whether the key has been changed, using the combined key, there is no need to separately allocate a storage space for storing metadata to each of the plurality of data blocks, and thus, the storage space can be efficiently utilized. For example, the memory device 130 can generate a combined key based on metadata and a MEK. The memory device 130 can generate encrypted user data (User Data 2) by encrypting user data based on the combined key, and can generate CRC based on the User Data 2. Since the memory device 130 can detect whether the key has been changed even when only the User Data 2 and the CRC are stored in the non-volatile memory, the non-volatile memory of the memory device 130 can be configured as a data block having a size smaller than that of the data block of the comparative implementation.

The memory device of the comparative implementation can perform a hash operation to reduce a storage space for storing the Key Metadata. The hash operation can mean an operation of converting given data into a fixed length. For example, the Key Metadata can be cut into 1 to 4 bytes. When a hash operation is performed, a storage space for storing the Key Metadata can be reduced, but a metadata collision problem of mistaking different metadata for the same metadata can occur.

In contrast, the memory device 130 according to the implementation of the present disclosure generates a combined key based on the entire metadata, thereby eliminating the risk of metadata collision.

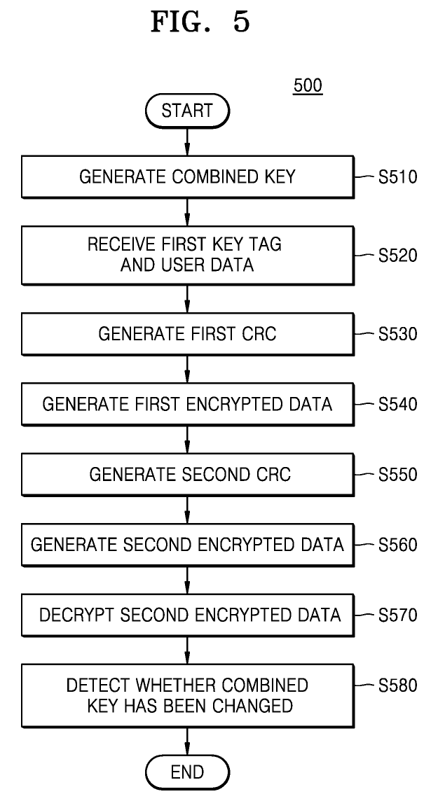

FIG. 5 is a flowchart illustrating an operating method 500 of an example of a memory device. Referring to FIG. 5, the operating method 500 of a memory device can include a plurality of operations S510 to S580, and the memory device can be the same as the memory device 130 of FIG. 1.

Referring further to FIGS. 1 and 2, operation S510 can be an operation performed after operation S210 and can be an example of operation S220. In operation S510, the memory device 130 can generate a combined key. In some implementations, the memory device 130 can generate a plurality of combined keys including a first key corresponding to a MEK and a second key corresponding to metadata, and can map at least one key tag and a plurality of combined keys to each of the plurality of key indexes on a one-to-one basis.

In operation S520, the memory device 130 can receive the first key tag and the user data. In some implementations, the memory device 130 can receive a write command from the host 120. The write command can include a first key tag (KeyTag 0) among at least one key tag and user data.

In operation S530, the memory device 130 can generate a first CRC. In some implementations, the memory device 130 can generate the first CRC based on the received user data.

In operation S540, the memory device 130 can generate first encrypted data. In some implementations, the memory device 130 can generate first encrypted data by encrypting received user data based on any one of the first key and the second key of the combined key (e.g., a first combined key (Combined Key 0)) mapped to the KeyTag 0. For example, the first encrypted data can be data encrypted with the first key or data encrypted with the second key.

In operation S550, the memory device 130 can generate a second CRC. In some implementations, the memory device 130 can generate the second CRC based on the encrypted user data.

In operation S560, the memory device 130 can generate second encrypted data. In some implementations, the memory device 130 can generate second encrypted data by encrypting first encrypted data based on any one of the first key and the second key of the combined key (e.g., a first combined key (Combined Key 0)) mapped to the KeyTag 0. For example, when the first encrypted data is generated based on the first key, the memory device 130 can generate the second encrypted data based on the second key, and when the first encrypted data is generated based on the second key, the memory device 130 can generate the second encrypted data based on the first key. The memory device 130 can store the first CRC, the second CRC, and the second encrypted data in the non-volatile memory.

In operation S570, the memory device 130 can decrypt second encrypted data. In some implementations, the memory device 130 can receive a read command from the host 120. The read command can include a first key tag (KeyTag 0) among at least one key tag. The memory device 130 can generate first decrypted data by decrypting second encrypted data based on any one of the first key and the second key included in the combined key (e.g., a first combined key (Combined Key 0)) mapped to the KeyTag 0. For example, the read command can further include information on either the first key or the second key, and can generate first decrypted data based on the information.

In operation S580, the memory device 130 can detect whether the combined key has been changed. In some implementations, the memory device 130 can generate a second comparison CRC based on the first decrypted data, and can compare the second comparison CRC with the second CRC to detect whether the combined key has been changed.

For example, when the first decrypted data is decrypted with the first key, the memory device 130 can compare the second comparison CRC with the second CRC to detect whether the first key has been changed in response to whether the second comparison CRC with the second CRC match each other. When the first key has been changed, the memory device 130 can generate an error code indicating that the first key has been changed. For example, when the first decrypted data is decrypted with the second key, the memory device 130 can compare the second comparison CRC with the second CRC to detect whether the second key has been changed in response to whether the second comparison CRC with the second CRC match each other. When the second key has been changed, the memory device 130 can generate an error code indicating that the second key has been changed.

In some implementations, when the key used to decrypt the first decrypted data has not been changed, the memory device 130 can generate second decrypted data and generate a first comparison CRC based on the second decrypted data. The memory device 130 can compare the first comparison CRC with the first CRC to detect whether the combined key has been changed.

For example, when the first key has not been changed, the memory device 130 can generate second decrypted data by decrypting the first decrypted data based on the second key, and can generate first comparison CRC based on the second decrypted data. The memory device 130 can compare the first comparison CRC with the first CRC to detect whether the second key has been changed. When the second key has been changed, the memory device 130 can generate an error code indicating that the second key has been changed. For example, when the second key has not been changed, the memory device 130 can generate second decrypted data by decrypting the first decrypted data based on the first key, and can generate first comparison CRC based on the second decrypted data. The memory device 130 can compare the first comparison CRC with the first CRC to detect whether the first key has been changed. When the first key has been changed, the memory device 130 can generate an error code indicating that the first key has been changed.

The operating method 500 of the memory device 130 according to the present disclosure can detect whether each of a first key corresponding to a MEK and a second key corresponding to metadata has been changed, and a different error code can be generated in response thereto.

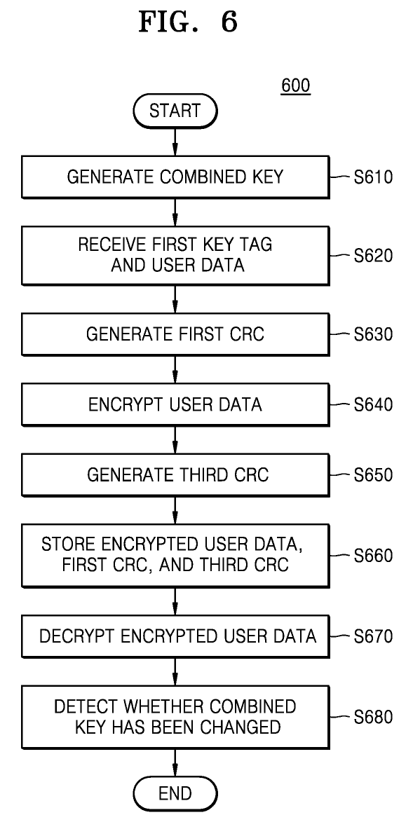

FIG. 6 is a flowchart illustrating an operating method 600 of an example of a memory device. Referring to FIG. 6, the operating method 600 of a memory device can include a plurality of operations S610 to S680, and the memory device can be the same as the memory device 130 of FIG. 1. In some implementations, operation S610 can be an example of operation S220 of FIG. 2, and operations S620 to S640 can be examples of operation S230 of FIG. 2. Redundancy descriptions with those described with reference to FIGS. 1 and 2 are omitted.

Referring further to FIG. 1, in operation S650, the memory device 130 can generate a third CRC. In some implementations, the memory device 130 can generate the third CRC based on the encrypted user data.

In operation S660, the memory device 130 can store the encrypted user data, the first CRC, and the third CRC in the non-volatile memory. In some implementations, the memory device 130 can include a non-volatile memory including a plurality of data blocks, and can store encrypted user data, the first CRC, and the third CRC in each of the plurality of data blocks.

In operation S670, the memory device 130 can decrypt the encrypted user data. In some implementations, when performing a read operation, the memory device 130 can generate a third comparison CRC based on stored encrypted user data before performing decryption, and can compare the third comparison CRC with the third CRC. When the third comparison CRC and the third CRC do not match each other, the memory device 130 can generate a second error code indicating that data stored in the non-volatile memory has been changed. When the third comparison CRC and the third CRC match each other, the memory device 130 can decrypt the encrypted user data.

In operation S680, the memory device 130 can detect whether the combined key has been changed. In some implementations, the memory device 130 can generate a first comparison CRC based on the decrypted user data, and can compare the first comparison CRC with the first CRC to detect whether the combined key has been changed. For example, when the first comparison CRC and the first CRC match each other, the memory device 130 can detect that the combined key has not been changed, and when the first comparison CRC and the first CRC do not match each other, the memory device 130 can detect that the combined key has been changed.

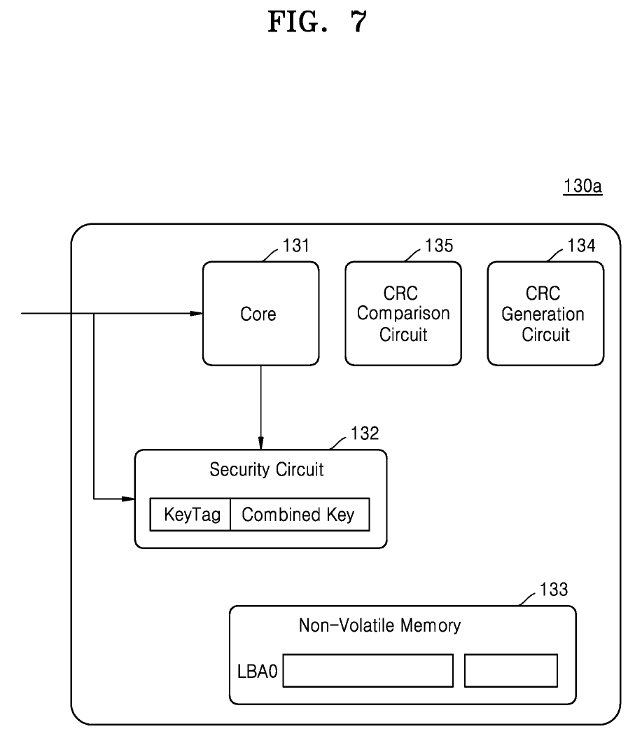

FIGS. 7 to 9 are block diagrams illustrating operations of a memory device 130a according to an implementation. The memory device 130a of FIGS. 7 to 9 can be an example of the memory device 130 of FIG. 1, and a redundant description thereof is omitted.

The memory device 130a of FIGS. 7 to 9 can include at least one core 131, a security circuit 132, a non-volatile memory 133, a CRC generation circuit 134, and a CRC comparison circuit 135.

FIG. 7 is a diagram illustrating an example process of generating a combined key of the memory device 130a. Referring to FIG. 7, the host 120 of FIG. 1 can perform an injection operation of injecting a user data encryption key MEK, metadata for the user data encryption key MEK, and at least one key tag (KeyTag) into the memory device 130a.

In some implementations, the at least one core 131 can receive a MEK and metadata from the host 120 of FIG. 1, and can generate a combined key based on the received MEK and metadata. For example, the at least one core 131 can perform an XOR operation to generate a combined key. For example, the at least one core 131 can generate a first key corresponding to the MEK and a second key corresponding to metadata as a combined key.

In some implementations, the security circuit 132 can receive at least one key tag (KeyTag) from the host 120 of FIG. 1 and can receive a combined key from the at least one core 131. The security circuit 132 can map the received at least one key tag and the combined key to a key index on a one-to-one basis. The mapped information can be stored in a volatile memory.

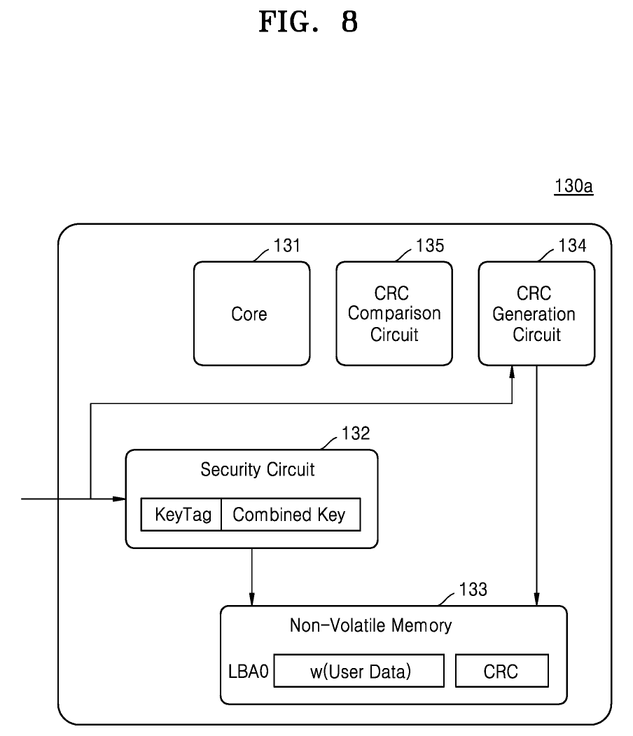

FIG. 8 is a diagram illustrating an example process of performing a write operation of the memory device 130a. Referring to FIG. 8, the memory device 130a can perform a write operation.

In some implementations, the security circuit 132 can receive a write command from the host 120 of FIG. 1. The write command can include a specific key tag among at least one key tag and user data. The security circuit 132 can generate encrypted user data w(User Data) by encrypting the received user data based on the combined key mapped to a specific key tag among the combined keys.

In some implementations, the CRC generation circuit 134 can receive user data from the host 120 of FIG. 1 during performing a write command, and can generate a CRC based on the received user data.

In some implementations, the non-volatile memory 133 can include a plurality of data blocks. The non-volatile memory 133 can receive encrypted w(user data) from the security circuit 132, receive CRC from the CRC generation circuit 134, and store encrypted w(User Data) and the CRC in the same data block (e.g., a data block corresponding to LBA0).

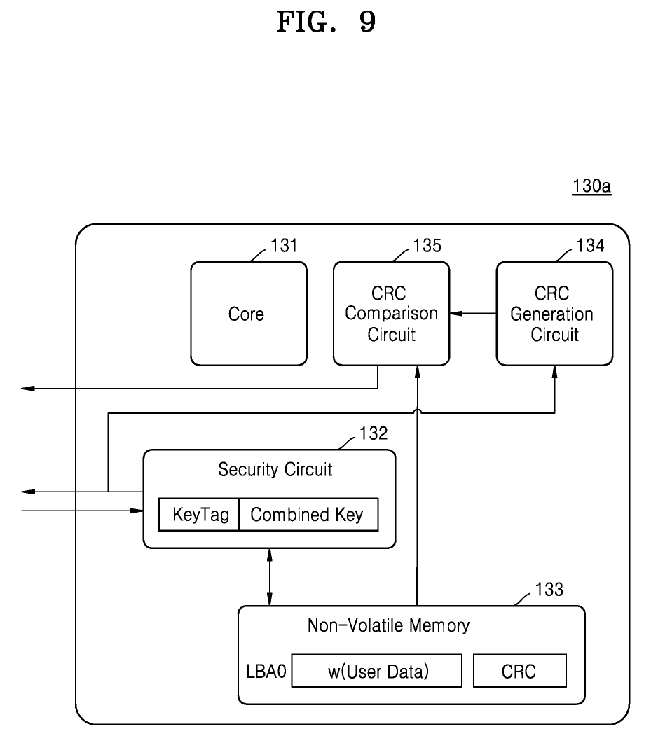

FIG. 9 is a diagram illustrating an example process of performing a read operation of the memory device 130a. Referring to FIG. 9, the memory device 130a can perform a read operation.

In some implementations, the security circuit 132 can receive a read command from the host 120 of FIG. 1. The read command can include a specific key tag among at least one key tag. The security circuit 132 can generate decrypted user data by decrypting the encrypted user data w(User Data) stored in the non-volatile memory 133 based on the combined key mapped to a specific key tag among the combined keys.

In some implementations, the CRC generation circuit 134 can receive decrypted user data from the security circuit 132 and generate a comparison CRC based on the received decrypted user data.

In some implementations, the CRC comparison circuit 135 can receive a comparison CRC from the CRC generation circuit 134, and can compare the CRC stored in the non-volatile memory 133 with the comparison CRC to detect whether a combined key mapped to a specific key tag has been changed. For example, when CRC and comparison CRC do not match each other, the CRC comparison circuit 135 can generate an incorrect key error, which is an error code indicating that the combined key mapped to a specific key tag has been changed, and output the incorrect key error to the host 120 of FIG. 1. For example, when CRC and comparison CRC match each other, the CRC comparison circuit 135 can output a corresponding signal to the security circuit 132, and the security circuit 132 can output decrypted user data to the host 120 of FIG. 1 in response to the signal of the CRC comparison circuit 135.

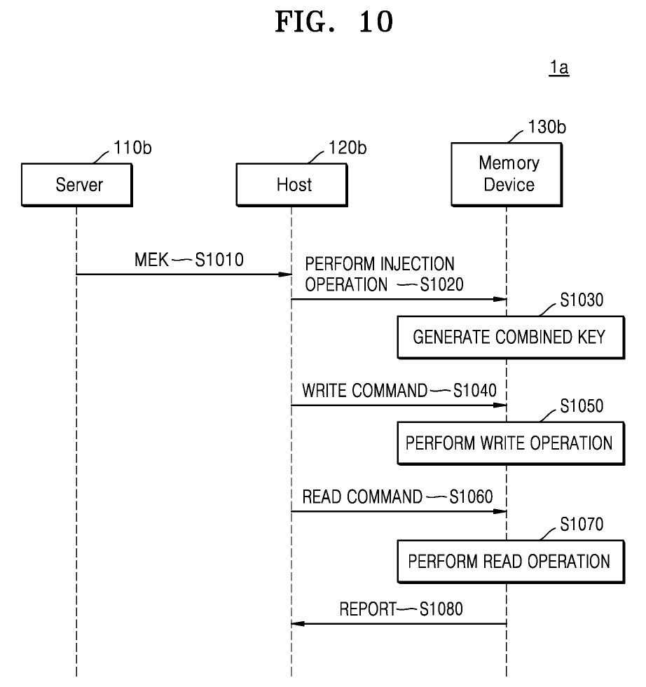

FIG. 10 is a flowchart illustrating an example of an operating method 1a of a memory system according to an implementation. Referring to FIG. 10, the operating method 1a of a memory system can include a plurality of operations S1010 to S1080, and a server 110b, a host 120b, and a memory device 130b can be respectively the same as the server 110, the host 120, and the memory device 130 of FIG. 1.

In operation S1010, the server 110b can generate a user data encryption key MEK in advance and transmit the generated MEK to the host 120b, or transmit data including information of the MEK to the host 120b.

In operation S1020, the host 120b can perform an injection operation. In some implementations, an injection operation of injecting at least one key tag, user data encryption key, and metadata into the memory device 130b can be performed.

In operation S1030, the memory device 130b can generate a combined key. In some implementations, the memory device 130b can generate a combined key based on metadata and a user data encryption key, and can map at least one key tag and the combined key on a one-to-one basis.

In operation S1040, the host 120b can transmit a write command to the memory device 130b. The write command can include a specific key tag among at least one key tag and user data.

In operation S1050, the memory device 130b can perform a write operation. In some implementations, the memory device 130b can generate CRC and encrypted user data based on the received write command. For example, the memory device 130b can generate CRC based on the received user data and generate encrypted user data by encrypting user data based on a combined key mapped to a specific key tag.

In operation S1060, the host 120b can transmit a read command to the memory device 130b. The read command can include a specific key tag among at least one key tag.

In operation S1070, the memory device 130b can perform a read operation. In some implementations, the memory device 130b can generate decrypted user data based on the received read command and detect whether the combined key has been changed. For example, decrypted user data can be generated by decrypting encrypted user data based on a combined key mapped to a specific key tag, and comparative CRC can be generated based on decrypted user data. The memory device 130b can compare the comparison CRC with the stored CRC to detect whether the combined key has been changed. The memory device 130b can detect that the combined key has been changed when the comparison CRC does not match the stored CRC, and can detect that the combined key has not been changed when the comparison CRC matches the stored CRC.

In operation S1080, the memory device 130b can perform a report to the host 120b. In some implementations, when detecting that the combined key has been changed, the memory device 130b can report, to the host 120b, an error code indicating that the combined key has been changed. When detecting that the combined key has not been changed, the memory device 130b can report the decrypted user data to the host 120b.

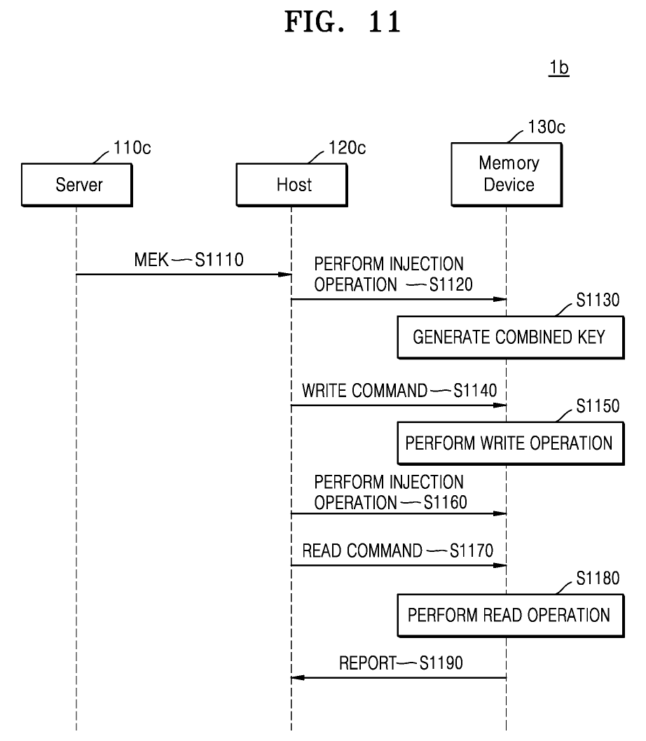

FIG. 11 is a flowchart illustrating an example of an operating method 1b of a memory system according to another implementation. Referring to FIG. 11, the operating method 1b of a memory system can include a plurality of operations S1110 to S1180, and a server 110c, a host 120c, and a memory device 130c can be respectively the same as the server 110, the host 120, and the memory device 130 of FIG. 1.

In some implementations, the operating method 1b of a memory system can be a method in which operation S1160 is added to the operating method 1a of the memory system of FIG. 10. For example, operations S1110, S1120, S1130, S1140, S1150, S1170, S1180, and S11190 can be respectively the same as the operations S1010, S1020, S1030, S1040, S1060, S1070, and S1080 of FIG. 10.

In operation S1160, the host 120c can perform an injection operation when the power of the memory device 130c is turned off before transmitting the read command to the memory device 130c. The mapped information can be stored in a volatile memory of the memory device 130c, and the mapped information can be volatilized when the power is turned on after being turned off. The host 120c can perform an injection operation into the memory device 130c before transmitting the read command, and the injection operation can be the same as in operation S1120.

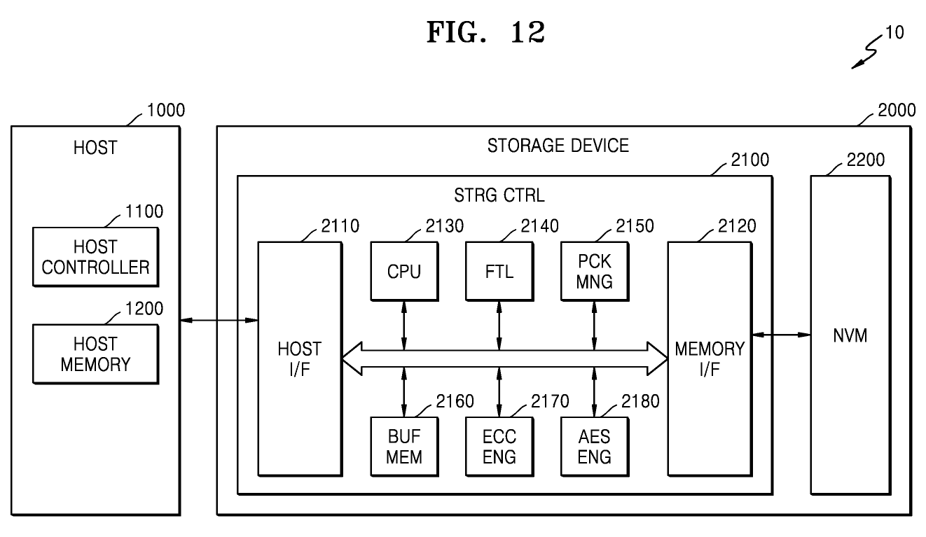

FIG. 12 is a block diagram illustrating an example of a host-storage system 10.

The host-storage system 10 can include a host 1000 and a storage device 2000. In addition, the storage device 2000 can include a storage controller 2100 and a non-volatile memory 2200. In addition, the host 1000 can include a host controller 1100 and a host memory 1200. The host memory 1200 can function as a buffer memory for temporarily storing data to be transmitted to the storage device 2000 or data transmitted from the storage device 2000.

The storage device 2000 can include storage media for storing data according to a request from the host 1000. As an example, the storage device 2000 can include at least one of a solid state drive (SSD), an embedded memory, and a removable external memory. When the storage device 2000 is an SSD, the storage device 2000 can be a device that complies with a non-volatile memory express (NVMe) standard. When the storage device 2000 is an embedded memory or an external memory, the storage device 2000 can be a device that complies with a universal flash storage (UFS) or an embedded multi-media card (eMMC) standard. The host 1000 and the storage device 2000 can generate packets and transmit the generated packets to each other according to the adopted standard protocols, respectively.

When the non-volatile memory 2200 of the storage device 2000 includes a flash memory, the flash memory can include a two-dimensional (2D) NAND memory array or a three-dimensional (3D) (or vertical) NAND (VNAND) memory array. As another example, the storage device 2000 can include various other types of non-volatile memories. For example, the storage device 2000 can employ magnetic random access memory (MRAM), spin-transfer torque MRAM, conductive bridging RAM (CBRAM), ferroelectric RAM (FeRAM), phase RAM (PRAM), resistive RAM, and other various types of memory.

In some implementations, the storage device 2000 can generate the combined key described above with reference to FIGS. 1 to 11, and can perform input/output processing operations based on the generated combined key. For example, the storage device 2000 can receive a user data encryption key and metadata about the user data encryption key from the host 1000 and generate a combined key based on the user data encryption key and metadata. Based on the generated combined key, the storage device 2000 can encrypt and decrypt user data, and can detect whether the combined key has been changed without storing the metadata in the non-volatile memory 2200.

According to an implementation, the host controller 1100 and the host memory 1200 can be implemented as separate semiconductor chips. Alternatively, in some implementations, the host controller 1100 and the host memory 1200 can be integrated into the same semiconductor chip. For example, the host controller 1100 can be any one of a plurality of modules provided in an application processor, and the application processor can be implemented as a system on chip (SoC). In addition, the host memory 1200 can be an embedded memory provided in the application processor, or a non-volatile memory or memory module placed outside the application processor.

The host controller 1100 can manage an operation of storing data (e.g., write data) of the buffer area of the host memory 1200 in the non-volatile memory 2200 or storing data (e.g., read data) of the non-volatile memory 2200 in the buffer area.

The storage controller 2100 can include a host interface (I/F) 2110, a memory interface (I/F) 2120, and a central processing unit 2130. In addition, the storage controller 2100 can further include a flash translation layer (FTL) 2140, a packet manager 2150, a buffer memory 2160, an error correction code (ECC) engine 2170, and an advanced encryption standard (AES) engine 2180. The storage controller 2100 can further include a working memory (not shown) in which the FTL 2140 is loaded, and data recording and reading operations with respect to the non-volatile memory 2200 can be controlled by the CPU 2130 executing the FTL.

The host I/F 2110 can transmit and receive packets to and from the host 1000. A packet transmitted from the host 1000 to the host interface 2110 can include a command or data to be recorded in the non-volatile memory 2200, and a packet transmitted from the host interface 2110 to the host 1000 can include a response to the command or data read from the non-volatile memory 2200. The memory interface 2120 can transmit data to be recorded in the non-volatile memory 2200 to the non-volatile memory 2200 or can receive data read from the non-volatile memory 2200. The memory interface 2120 can be implemented to comply with standard protocols such as toggle or open NAND flash interface (ONFI).

The FTL 2140 can perform various functions such as address mapping, wear-leveling, and garbage collection. The address mapping operation is an operation of converting a logical address received from the host 1000 into a physical address used to actually store data in the non-volatile memory 2200. The wear-leveling is technology for preventing excessive deterioration of a specific block by uniformly using blocks in the non-volatile memory 2200, and can be implemented through firmware technology that balances erase counts of physical blocks, for example. The garbage collection is a technology for securing usable capacity in the non-volatile memory 2200 by erasing the existing block after copying the effective data of the block to a new block.

The packet manager 2150 can generate a packet according to a protocol of an interface negotiated with the host 1000 or can parse various types of information from the packet received from the host 1000. In addition, the buffer memory 2160 can temporarily store data to be recorded in the non-volatile memory 2200 or data read from the non-volatile memory 2200. The buffer memory 2160 can be a component provided in the storage controller 2100, but can be arranged outside the storage controller 2100.

The ECC engine 2170 can perform an error detection and correction function on read data read from the non-volatile memory 2200. More specifically, the ECC engine 2170 can generate parity bits for the write data to be written to the non-volatile memory 2200, and the generated parity bits can be stored in the non-volatile memory 2200 together with the write data. When data is read from the non-volatile memory 2200, the ECC engine 2170 can correct an error in the read data using parity bits read from the non-volatile memory 2200 together with the read data, and output error-corrected read data.

The AES engine 2180 can perform at least one of an encryption operation and a decryption operation for data input to the storage controller 2100 using a symmetric-key algorithm.

While the inventive concept has been particularly shown and described with reference to implementations thereof, it will be understood that various changes in form and details can be made therein without departing from the spirit and scope of the following claims.

What is claimed is:

1. A memory system comprising:
a host configured to receive a user data encryption key from a server; and
a memory device configured to:
receive, from the host, user data, the user data encryption key, and metadata for the user data encryption key,
generate a combined key based on the user data encryption key and the metadata,
during a write operation, (i) generate encrypted user data by encrypting the user data based on the combined key, (ii) generate a first cyclic redundancy check (CRC) based on the user data, and (iii) store the encrypted user data and the first CRC, and
during a read operation, (i) generate decrypted user data by decrypting the encrypted user data based on the combined key, (ii) generate a first comparison CRC based on the decrypted user data, and (iii) detect a change in the combined key based on comparing the first CRC with the first comparison CRC.

2. The memory system of claim 1, wherein the memory device is configured to generate the combined key by performing an exclusive OR (XOR) operation on the user data encryption key and the metadata.

3. The memory system of claim 1, wherein the combined key comprises a first key corresponding to the user data encryption key and a second key corresponding to the metadata, and
wherein the memory device is configured to:
during the write operation, (i) generate first encrypted data by encrypting the user data based on the first key, (ii) generate the first CRC based on the user data, (iii) generate second encrypted data by encrypting the first encrypted data based on the second key, (iv) generate a second CRC based on the first encrypted data, and (v) store the second encrypted data, the first CRC, and the second CRC, and
during the read operation, detect a change in the combined key based on a comparison result generated based on the first CRC and the second CRC.

4. The memory system of claim 1, wherein the memory device comprises a non-volatile memory including a plurality of data blocks, and
wherein the non-volatile memory is configured to store the encrypted user data and the first CRC in a same data block among the plurality of data blocks.

5. The memory system of claim 1, wherein the memory device comprises:
a CRC generation circuit configured to generate the first CRC, and
a CRC comparison circuit configured to determine that the first CRC matches the first comparison CRC, and
wherein the CRC comparison circuit is configured to, based on determining that the first CRC does not match the first comparison CRC, output a first error code to the host.

6. The memory system of claim 5, wherein the CRC generation circuit is configured to:
generate a third CRC based on the generated encrypted user data during the write operation, and
generate a second comparison CRC based on the stored encrypted user data during the read operation, and
wherein the CRC comparison circuit is configured to, based on determining that the third CRC does not match the second comparison CRC, output a second error code to the host.

7. The memory system of claim 1, wherein the host is configured to perform an injection operation of injecting at least one key tag, the user data encryption key, and the metadata into the memory device, and
wherein the memory device comprises:
at least one core configured to generate the combined key based on the user data encryption key and the metadata, and
a security circuit configured to map the at least one key tag and the combined key on a one-to-one basis based on the host performing the injection operation.

8. The memory system of claim 7, wherein the host is configured to perform the injection operation before and after performing the write operation.

9. The memory system of claim 7, wherein the security circuit is configured to, during the write operation , (i) receive, from the host, the user data and a first key tag of the at least one key tag, and (ii) generate and store encrypted user data by encrypting the user data based on a combined key mapped to the first key tag.

10. The memory system of claim 9, wherein the security circuit is configured to, during the read operation, (i) receive the first key tag from the host and (ii) generate decrypted user data by decrypting the encrypted user data stored based on the combined key mapped to the first key tag.

11. A memory device comprising:
at least one core configured to generate a combined key based on a user data encryption key and metadata for the user data encryption key;
a security circuit configured to (i) generate encrypted user data by encrypting user data based on the combined key during a write operation, and (ii) generate decrypted user data by decrypting the encrypted user data based on the combined key during a read operation;
a cyclic redundancy check (CRC) generation circuit configured to (i) generate a first CRC based on the user data and (ii) generate a first comparison CRC based on the decrypted user data;
a non-volatile memory configured to store the encrypted user data and the first CRC; and
a CRC comparison circuit configured to detect a change in the combined key based on comparing the first CRC with the first comparison CRC.

12. The memory device of claim 11, wherein the at least one core is configured to generate the combined key by performing an exclusive OR (XOR) operation on the user data and the metadata.

13. The memory device of claim 11, wherein the security circuit is configured to (i) receive at least one key tag from a host, (ii) receive the combined key from the at least one core, and (iii) map the at least one key tag and the combined key on a one-to-one basis.

14. The memory device of claim 13, wherein the security circuit is configured to,
during the write operation, (i) receive, from the host, the user data and a first key tag of the at least one key tag and (ii) generate encrypted user data by encrypting the user data based on a combined key mapped to the first key tag, and
during the read operation, (i) receive the first key tag from the host and (ii) generate decrypted user data by decrypting the encrypted user data stored based on the combined key mapped to the first key tag.

15. The memory device of claim 11, wherein the non-volatile memory comprises a plurality of data blocks corresponding to a plurality of logical block addresses (LBA), and
wherein the non-volatile memory is configured to store the encrypted user data and the first CRC in a same data block among the plurality of data blocks.

16. An operating method of a memory device, the operating method comprising:
receiving, from a host, at least one key tag, a user data encryption key, and metadata;
generating a combined key based on the user data encryption key and the metadata;
mapping the at least one key tag and the combined key on a one-to-one basis;
receiving, from the host, user data and a first key tag among the at least one key tag;
generating a first cyclic redundancy check (CRC) based on the user data;
generating encrypted user data by encrypting the user data based on the combined key mapped to the first key tag;
generating decrypted user data by decrypting the encrypted user data based on the combined key mapped to the first key tag;
generating a first comparison CRC based on the decrypted user data; and
detecting a change in the combined key based on comparing the first comparison CRC with the first CRC.

17. The operating method of claim 16, wherein generating the combined key based on the user data encryption key and the metadata comprises:
generating the combined key by performing an XOR operation.

18. The operating method of claim 16, comprising:
storing the encrypted user data and the first CRC in a same data block among a plurality of data blocks included in the memory device after the encrypted user data and the first CRC are generated.

19. The operating method of claim 16, wherein detecting the change in the combined key comprises:
comparing the first CRC with the first comparison CRC, and
based on the first CRC not matching the first comparison CRC, outputting, to the host, a first error code indicating that the combined key has been changed.

20. The operating method of claim 16, wherein generating the decrypted user data comprises:
receiving the first key tag again from the host, and
generating decrypted user data by decrypting the encrypted user data based on the combined key mapped to the first key tag that has been received again from the host.
